(19) United States
(12) Patent Application Publication
(10) Pub. No.: US 2023/0229905 A1
(43) Pub. Date: Jul. 20, 2023

(54) CHECKPOINT STATE STORAGE FOR MACHINE-LEARNING MODEL TRAINING

(71) Applicant: Microsoft Technology Licensing, LLC, Redmond, WA (US)

(72) Inventor: Yuan YU, Cupertino, CA (US)

(73) Assignee: Microsoft Technology Licensing, LLC, Redmond, WA (US)

(21) Appl. No.: 17/578,326

(22) Filed: Jan. 18, 2022

(51) Int. Cl. G06N 3/08

(52) U.S. Cl. CPC G06N 3/08

(57) ABSTRACT

A method for training a machine-learning model. A plurality of nodes are assigned for training the machine-learning model. Nodes include agents comprising at least an agent processing unit and local memory. Each agent manages, via a local network, one or more workers that include a worker processing unit. Shards of a training data set are distributed for parallel processing by workers at different nodes. Each worker processing unit is configured to iteratively train on minibatches of a shard, and to report checkpoint states indicating updated parameters for storage in local memory. Based at least on recognizing a worker processing unit failing, the failed worker processing unit is reassigned and initialized based at least on a checkpoint state stored in local memory.

### BACKGROUND

Artificial neural networks have been implemented to perform various machine-learning tasks, such as image recognition, speech recognition, intelligent user interface applications, etc. Training such neural networks generally involves parsing large quantities of data with sets of highly-specialized processing machines. The training process may generate model parameters that inform a neural network, which is capable of identifying aspects of newly presented data.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method for training a machine-learning model. Nodes are assigned for training the machine-learning model. Nodes include agents comprising at least an agent processing unit and local memory. Each agent manages, via a local network, one or more workers that include a worker processing unit. Shards of a training data set are distributed for parallel processing by workers at different nodes. Each worker processing unit is configured to iteratively train on minibatches of a shard, and to report checkpoint states indicating updated parameters for storage in local memory. Based at least on recognizing a worker processing unit failing, the failed worker processing unit is reassigned and initialized based at least on a checkpoint state stored in local memory.

### BRIEF DESCRIPTION OF THE DRAWINGS

FIG. 1 schematically shows an example architecture for data-parallel training of a machine-learning model.

FIG. 2 schematically shows types of communication parallelism for a neural network.

FIG. 3 schematically shows a system for a distributed architecture for training a machine-learning model.

FIG. 4 schematically shows a system for local checkpointing for a system for training a machine-learning model.

FIG. 5 is a flow diagram for an example method for training a machine-learning model.

FIG. 6 schematically shows a system for reassigning and initializing a failed node of a training system.

FIG. 7 is a flow diagram for an example method for managing training of a machine-learning model.

FIG. 8 schematically shows a system for migrating a node of a training system.

FIG. 9 schematically depicts an example computing system.

### DETAILED DESCRIPTION

Training of machine-learning models can take a significant amount of time. Very large training sets of data may be used to accurately train a model. One approach to faster model training includes the use of distributed learning, where multiple model replicas are trained in parallel on processors using the same training data and are eventually combined to form a single model. Such training data may include thousands if not millions or billions of samples for use in training.

Deep neural networks (“DNNs”), for example, may be trained to solve complex classification problems such as object detection, semantic labeling, and feature extraction. As a result, DNNs may form the foundation for many artificial intelligence (“AI”) applications, such as computer vision, speech recognition, and machine translation. However, the high-level performance of DNNs comes at the cost of high computational complexity. DNN models may have between tens, hundreds, or more layers, commonly totaling 10-20 million parameters. It is believed that even larger neural networks may be desirable, including up to hundreds of billions or trillions of parameters.

DNN models can thus take a long time to train. For example, models for image classification tasks can often take days or even weeks to train using high performance, specific-purpose processors, such as graphics processing units (“GPUs”). More rapid training of large deep learning models is often performed through distributed training on many processors.

Herein, it should be understood that the components used in training a machine learning model include computers and/or aspects of computers and their components. In many examples, a significant number of separate computers, be they tangible and/or virtual machines (e.g., a server farm) work together in cooperation to execute this training process. As such, computing devices may be described in terms of their functions (e.g. schedulers, job managers, resource managers, workers, agents), or their relationship to other computing devices (e.g. nodes, pods, peers, peer groups). However, the fungible aspects of programming, training, assigning, monitoring, etc. are all performed by computer hardware aspects, particularly by logic machines, storage machines, communication subsystems, etc.

In distributed, or data-parallel training, each worker has a full copy of the model parameters and trains independently on a subset of the input data. The training data may be partitioned into shards, and then divided into batches, subsets, or minibatches of training data. Each worker may then receive minibatches of the training data from a respective shard for use in training replica models. Thus, the models may be trained using different data, but the parameters of the model, such as weights between nodes in the models will all be made equal in response to synchronization and parameter exchange.

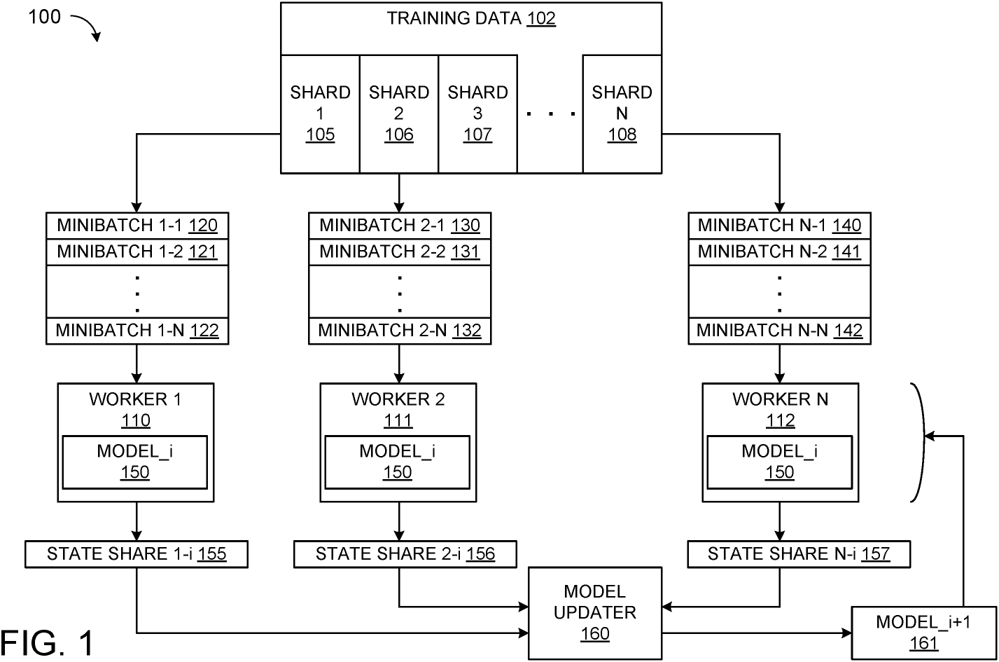

FIG. 1 shows an example system 100 for data parallel training of a machine-learning model. In this example, training data 102 is used to train parameters of a machine-learning model, such as the weights and/or gradients of a neural network. Training data set 102 may be divided into shards, e.g., shard 1 105, shard 2 106, shard 3 107, and shard N 108. The shards, in turn are forwarded to different nodes for processing. As shown here, shard 1 105 is forwarded to worker 1 110, shard 2 106 is forwarded to worker 2 111, and shard N 108 is forwarded to worker N 112.

Each node may include one or more worker processing units and one or more agent processing units configured to supervise one or more worker processing units. In general, each node contains multiple worker processing units, and an agent processing unit may monitor multiple worker processing units. Nodes may be implemented using a central processing unit (CPU), a GPU, a combination of CPUs and GPUs, or a combination of any CPUs, GPUs, ASICs, and/or other computer programmable hardware. To train large models in a reasonable amount of time, training can be performed in parallel across multiple GPUs using various mechanisms, including data-parallelism. In data-parallelism, or data-parallel processing, the training data set is partitioned across multiple GPUs. Each GPU maintains a full copy of the DNN model and trains on its own partition of training data, while periodically synchronizing model parameters with other GPUs. During data-parallel DNN training, GPUs frequently exchange model parameters with the other GPUs involved in training.

Herein, generally, agent processing units are described as being implemented with CPUs, while worker processing units are implemented with GPUs. However other configurations are possible. For example, some or all aspects may additionally or alternatively be implemented in cloud computing environments. Cloud computing environments may include models for enabling on-demand network access to a shared pool of configurable computing resources. Such a shared pool of configurable computing resources can be rapidly provisioned via virtualization, then scaled accordingly. A cloud computing model can be composed of various characteristics such as, for example, on-demand self-service, broad network access, resource pooling, rapid elasticity, measured service, and so forth.

Returning to FIG. 1, each of the shards may be divided into minibatches. As shown, shard 1 105 is divided into at least minibatch 1-1 120, minibatch 1-2 121, and minibatch 1-N 122. Shard 2 106 is divided into at least minibatch 2-1 130, minibatch 2-2 131, and minibatch 2-N 132. Shard N 108 is divided into at least minibatch N-1 140, minibatch N-2 141, and minibatch N-N 142.

The minibatches of each shard may be sequentially provided to workers one at a time. For example, worker 1 110 may receive a minibatch of training data, perform machine-learning training on model_i 150, and produce a state share 1-i 155 (e.g., a training result); worker 2 111 may receive a minibatch of training data, perform machine-learning training on model_i 150, and produce a state share 2-i 156; and worker N 112 may receive a minibatch of training data, perform machine-learning training on model i 150 and produce a state share N-I 157. The training results from each worker may then be combined at model updater 160 to produce an updated model_i+1 161, which may then be loaded into each worker for processing the next minibatch.

In this example, an iteration includes receiving one or more minibatches alongside other workers, processing the minibatches to produce results, and combining the results to produce an updated model. As used herein, an “epoch” occurs when every worker processes all their shards and one full training data set 102 has been processed once. The training data set 102 may be processed over multiple epochs to arrive at a final trained set of model parameters, following synchronization of the models for each worker.

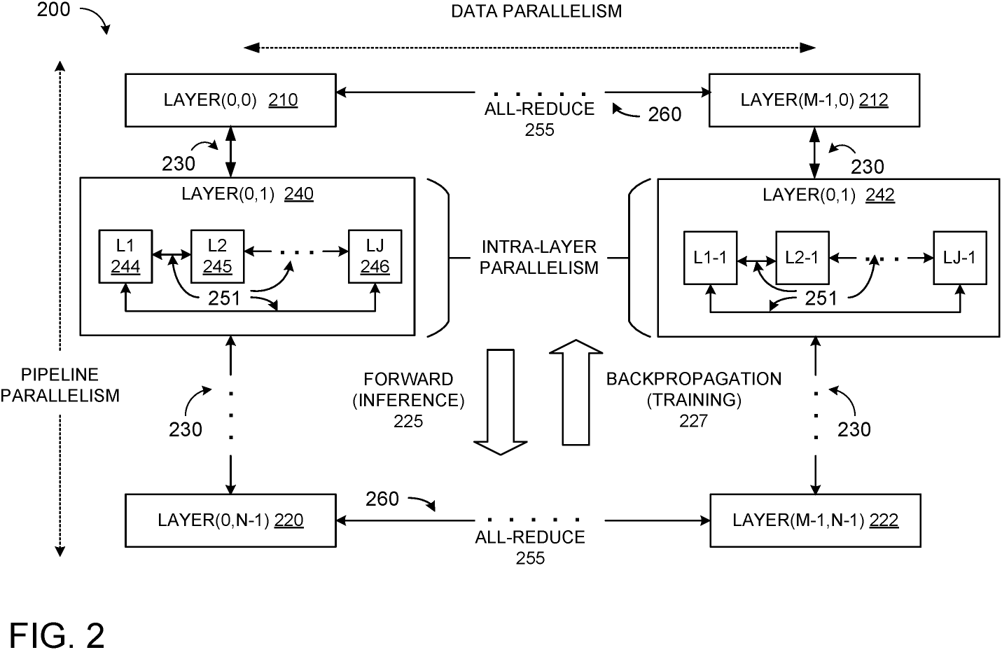

FIG. 2 illustrates communications across three axes of a neural network. In this example, a neural network model 200 is partitioned for layer parallelism, pipeline parallelism, and data parallelism. As described with regard to FIG. 1, data parallelism may include the exchange of data between multiple instances of the model executing on different processors. For instance, the same model may be trained in parallel by executing different instances of the model on different processors and periodically synchronizing weights in the various layers.

In this example, M (e.g., an integer) instances of the model receive input values on layers (0,0) 210 through (M-1,0) 212 and produce an output result on layers (0,N-1) 220 through (M-1,N-1) 222 during forward processing, or inference (225). During training, the data flows in the reverse direction during backpropagation (227), where an error between a network result and an expected result is determined at the output and the weights are updated layer by layer flowing from the output layer to the input layer. Accordingly, pipeline communications flow vertically as illustrated by arrows 230 (e.g., activations/errors).

Layers 240 and 242 may be assigned to run on multiple different processors. Here, intra-layer communications between J (e.g., an integer) processors (L1 244, L2 245, LJ 246, L1-1 247, L1-2 248, LJ-1 249) per layer are illustrated by arrows 251, where layers 240 and 242 are divided into J partitions, for example. Similarly, during training, weights in each of the models may be periodically synchronized. If instances of the neural network models are running on different processors (or distributed across multiple sets of different processors), then such processors may perform communications to update the weights (e.g., using an All Reduce algorithm 255, such as a 1-dimensional ring, multiple rings, a tree based algorithm, or a hierarchical algorithm).

Pipelines may operate independently during training but may need to synchronize their weights periodically across execution of different instances of the model. For instance, during an All Reduce 255, the weights may be updated layer by layer between instances. Accordingly, in some applications each layer of the pipeline may perform an All Reduce 255 periodically with other instances of the model as illustrated in FIG. 2 by arrows 260. Instances of models running in parallel may be configured in a ring, for example, where weight updates between the models may flow in both directions around the ring.

The performance and scalability of distributed learning processes with a large number of processors (e.g., workers) depends on the quality and frequency of parameter exchange among its workers, as well as the ability of the system to recover quickly and efficiently from failures. Models can be very large, with tens or hundreds of billions of primary neurons and parameters. Training these models may take weeks or even months, even with distributed training. Such training may incorporate thousands or even tens of thousands of worker processing units.

When performing training on this scale over an extended duration, each piece of the system is prone to failure - be it the network, the processors, etc. To guard against failure, the system may be periodically checkpointed, storing a checkpoint state (e.g., current parameters) so that any failure does not require the training to start at the very beginning, only at the most recent checkpoint.

Typically, the checkpoint state is saved to a global storage system. Recovery from a failure necessitates loading the checkpoint state to all processors from global storage and then restarting every processor from the checkpoint state. This approach results in significant overhead costs. Uploading the state requires a long checkpointing interval where no training occurs. Downloading the checkpoint state from global storage and restarting training results in an extended recovery time. Migrating workloads, even in the absence of a failure, also requires pausing and restarting training. As such, any inefficiencies in bandwidth use are likely to persist, as the cost savings pale to the overhead of reconfiguring the system.

As large-scale model training is scaled out to trillions of parameters, reliability and elasticity become increasingly important for both performance and cost. Herein, systems and methods are disclosed for rapid, lightweight checkpointing that increases reliability, aids in making training processes more elastic, and enables processor migration during the execution of large training jobs.

During training, each worker processor unit stores its share of the state locally in memory associated with an agent processor unit. If a worker processor unit fails, it can thus be recovered quickly based on the locally stored checkpoint state, as long as the respective agent is healthy. The agent processor units may replicate the stored checkpoint states to memory on other nodes to guard against failures. If an agent or node fails, their associated checkpoint states can be retrieved from one of the other replicas.

In this way, healthy portions of the system may be kept alive during local failures. In this context, “healthy” may indicate that the portion of the system displays no faults, or a sub-threshold degree of faultiness, and would thus not otherwise be designated for deletion and/or reassignment. Checkpointing thus only consumes local network traffic, not front end and back end networks In the common case where a worker fails, recovery only incurs light back end network traffic. As checkpointing is made to be fast and lightweight, it can be performed frequently (e.g., after each training iteration). Faults and elasticity/migration events can be detected and handled instantly, while recovery may be performed in near real time. This increases the reliability of the system, helps make training more elastic, and enables low-cost processor migration during the execution of large training jobs. $

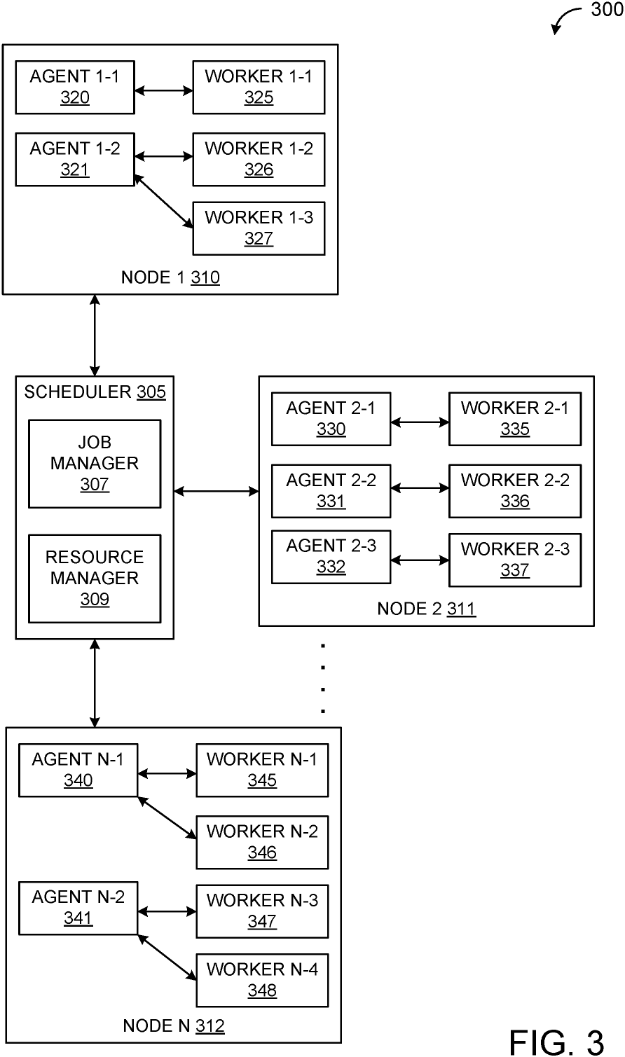

FIG. 3 schematically shows a system 300 for a distributed architecture for training a machine-learning model, such as a neural network. System 300 may be used to perform data-parallel training of the machine-learning model, as described with regard to FIGS. 1 and 2. System 300 may additionally or alternatively be considered to be at least part of a cluster.

System 300 includes a scheduler 305, which may include one or more computer processors. Scheduler 305 may include one or more network accessible computing devices programmed to provide a scheduling service that is responsible for managing resources for training jobs. In some examples, the functions of a scheduler 305 may be divided across at least a job manager 307 and a resource manager 309. Job manager may be configured to manage aspects of the training job, such as starting/restarting, synchronizing, distributing shards, etc. Resource manager 309 may be configured to manage aspects of the cluster such as bandwidth, elasticity, migration, etc.

System 300 may include a plurality of nodes. FIG. 3 shows node 1 310, node 2 311 and node N 312. N may be any suitable number for the training job based on the available resources. Each node includes a plurality of agents, each agent configured to manage one or more workers. Each training job may comprise a set of training workers and their agents. Each tandem of a worker and its associated agent may be considered a pod of the training job. Agents and workers within a common node may share certain resources, such as one or more local networks, storage subsystems, local services, etc.

Nodes may not necessarily include an equal number of agents and/or workers. In this example, node 1 310 includes agent 1-1 320 and agent 1-2 321. Agent 1-1 320 manages worker 1-1 325. Agent 1-2 manages worker 1-2 326 and worker 1-3 327. Node 2 311 includes agent 2-1 330, agent 2-2 331, and agent 2-3 332. Agent 2-1 330 manages worker 2-1 335. Agent 2-2 manages worker 2-2 336, and agent 2-3 manages worker 2-3 337. Node N 312 includes agent N-1 340 and agent N-2 341. Agent N-1 340 manages worker N-1 345 and worker N-2 346. Agent N-2 manages worker N-3 347 and worker N-4 348.

Combined or individually, scheduler 305 may be responsible for adding or deleting nodes for elasticity, adding or deleting nodes when faults are detected, and for coordinating with agents to start, pause, and/or restart the workers on the training job. Scheduler 305 may be responsible for allocating the resources being loaded. The scheduler may analyze the current state of the cluster and allocate a given number of workers across available node and agents.

Each agent may be considered to be one or more computer processes (e.g., software algorithms) running on a node. The agent processes may be responsible for spawning, monitoring, and restarting associated workers. For example, at the outset of a training job, a node may start the agents there within, and those agents may then subsequently spawn the workers. A single agent may manage one or many workers. Each agent communicates with both the scheduler and the workers it manages.

Each worker may also be considered to be one or more computer processes running on a node. The worker processes include performing the actual training work based on the state of the model and the training data. A combined set of all workers in system 300 constitute a compute plane. Workers may include one or more worker processing units. For example, such worker processing units may include graphics processors (GPUs), artificial intelligence (AI) accelerators, or other digital processors optimized for AI operations (e.g., matrix multiplications versus Von Neuman Architecture processors such as the x86 processor). Example AI processors may include GPUs (e.g., NVidia Volta® with 800 cores and 64 MultiAccumulators) or a Tensor Processor Unit (TPU) (e.g., 4 cores with 16 k operations in parallel), for example.

Scheduler 305 may receive a request for resources from a training job. Scheduler 305 may then be tasked with allocating and placement of resources (e.g., workers) for the training job. For large scale, distributed training, scheduler 305 may indicate training replicas, or data parallel training. The model is then implemented with a parallel degree of duplication. This speeds up training by leveraging many workers that all work on independent mini batches.

Having multiple (i.e., >=3) replicas allows the distributed system to achieve fault tolerance. Each worker operates on an independent mini batch, in parallel, and all workers are provided the full state. Although these workers have the same state, they perform different calculations on different minibatches based on the shared state. Each training replica thus has a share of the total state, and, if copied to other nodes, provides fault-saving redundancy without requiring the system to maintain all copies of the state with all nodes. This technical feature provides improved reliability of computing devices.

For globally distributed training, a coherent, consistent checkpointing of the state is needed to ensure the correctness of the entire training in result of a failure. Each checkpoint may be considered roughly equal to the current state of the training, indicating the current values of the parameters of the model. Such a checkpointing step typically occurs at the end of a training iteration. Each worker may start its computations with the same state, but since they all compute on different mini batches, each worker generates its own weights and parameters, e.g., a share of the total state. A parameter exchange step, such as an all reduce step allows the workers to exchange information, and to perform a circular communication that allows the set of workers to be synchronized. This is generally considered the safest time to take a checkpoint.

Such a checkpointing process incurs both a storage cost and a network traffic cost. Porting each worker’s share of the state to a global storage is both inefficient and costly, consuming significant amounts of storage space, extending the amount of time needed to complete the checkpointing, as well as extending the amount of time needed to restart training in the result of a failure. Due to these costs, some systems may elect to reduce the frequency of checkpointing events, such that when a failure does occur, the most recent checkpoint may have been taken several iterations in the past, leading to significant duplication of training work.

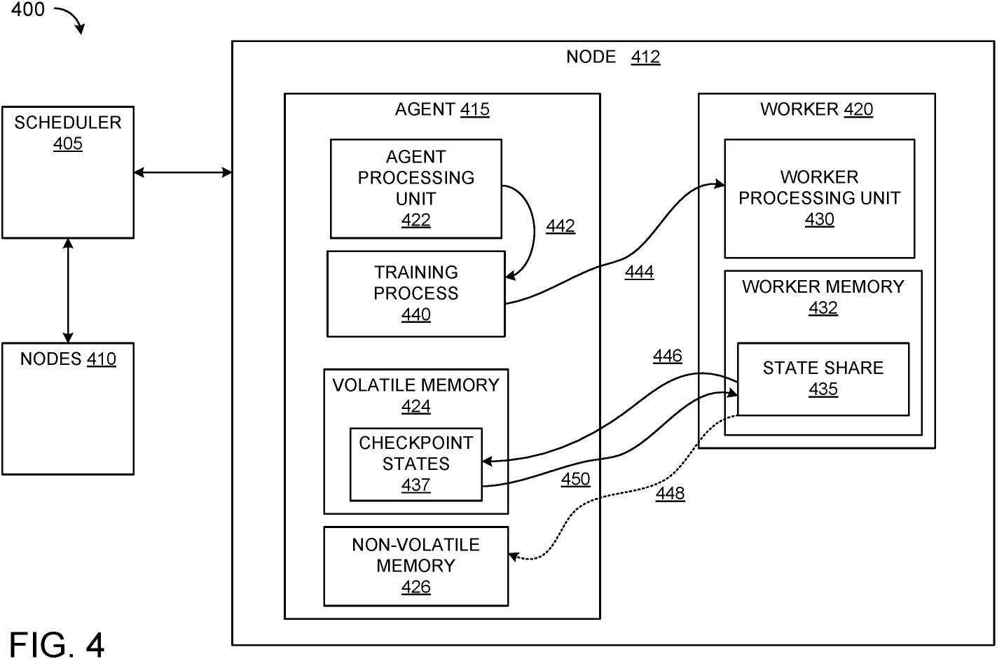

FIG. 4 schematically shows a system 400 for local checkpointing for a system for training a machine-learning model. System 400 may be an example of system 300. System 400 includes scheduler 405 and a plurality of nodes 410. For simplicity, a single node 412 is shown in detail. Node 412 is shown having a single agent 415 configured to manage a single worker 420, though additional agents and workers may be included as described with regard to FIG. 3. Agent 415 includes one or more agent processing units 422 (e.g., a CPU), volatile memory 424 and non-volatile memory 426. Worker 420 includes one or more worker processing units 430 (e.g., a GPU) and a worker memory 432. Worker 420 may maintain its state share 435 in worker memory 432. As long as agent 415 is considered “healthy” and is persistent across events such as faults and elasticity, checkpoint states 437 for worker 420 may be stored in local memory (e.g., volatile memory 424).

Scheduler 405 may distribute and initiate training process 440 to agent 415. For example, training process 440 may include instructions to workers to distributively perform a single program, multiple data (SPMD) computation As indicated at 442, agent processing unit 422 may fork training process 440 so that training process 440 may be run by worker processing unit 430. An initial state share 435 may be stored at worker memory 432. Following a training iteration, state share 435 may be updated based on the minibatch trained on during the training iteration.

Training process 440 may initiate a checkpointing at worker processing unit 430, as indicated at 444. In response, worker processing unit 430 may copy the current state share 435 to volatile memory 424 as a checkpoint state 437, as indicated at 446. In some examples, if volatile memory 424 is full or otherwise unavailable, state share 435 may be copied to non-volatile memory 426, as indicated at 448.

Each worker thus generates a share of the checkpoint state. For any such examples where the degree of data parallelism is >= three, fault tolerance is achieved without further backup. In other examples, agent 415 may distribute two or more copies of checkpoint states 437 to the local memory of other agents. In either configuration, there is enough replication so that the entire state is stored in triplicate across system 400, and thus there is no need for each state share to be written to a global storage backup at each checkpointing.

However, each agent 415 may be further configured to upload checkpoint states 437 from local memory to a global storage backup at a lower frequency than checkpoint states 437 are recorded at the respective agent 415. In other words, a global backup may be generated infrequently, e.g., daily, following a threshold number of training iterations, following a threshold number of faults. In this way, a catastrophic failure (e.g., power outage, other cluster-wide failures) may be warded off without the cost of generating a backup state at each training iteration. This technical feature provides improved reliability of computing devices.

In some examples, each worker 420 may be configured to report checkpoint states 437 based at least on a most recent training iteration to a respective agent 415 following progression of worker 420 to a subsequent training iteration. For example, the checkpoint state may be reported while the worker processing unit is performing the forward and/or backward computations of the next minibatch.

This asynchronous copying can significantly decrease checkpointing overhead, down to the order of a few milliseconds per training iteration. Similarly, in examples where agent 415 is configured to distribute copies of checkpoint states 437 to other agents, this distribution can also occur asynchronously, e.g., during the checkpointing interval. The technical feature enables the optimized consumption of computing resources.

Scheduler 405 may be configured to monitor and manage progress of nodes 410 and 412 so that all workers are within a threshold number of iterations. For example, if the threshold is set to 2 iterations, and one worker is on iteration N and another worker is on iteration N+1, then all workers may be maintained to be on either iteration N or N+1. In such a scenario, agent 415 may maintain two checkpoint states 437 for worker 420, correlating to the checkpoint states of the last two iterations completed by worker 420.

For example, R:N may be used as a unique identifier for the checkpoint state of rank R at the Nth iteration. At each iteration, the training process instructs every worker to checkpoint its state independently so the checkpoints from the workers (R:N) collectively form a globally consistent checkpoint for the entire computation.

System 400, and services running thereon, may monitor the health of nodes 410 and 412. Scheduler 405 may also perform some lower level failure detection. In response to a failure being detected, scheduler 405 is informed and then makes a decision about whether the entire system will revert to the previous checkpoint.

Node 412 and agent 415 may more closely monitor the health of worker 420 and any other associated workers in order to recognize an associated worker processing unit (e.g., worker processing unit 430) failing. For example, at every training iteration, a minibatch is processed. If one worker processing unit does not complete the iteration, the all reduce step cannot be performed, and a fault is indicated. Agent 415 may initialize and restart the failed worker processing unit based on a checkpoint state 437 stored in local memory. As indicated at 450, a checkpoint state 437 may be copied to state share 435 in worker memory 432, and then worker processing unit 430 may proceed with the training iteration. In general, each worker will be restarted from a common checkpoint. In some examples, healthy workers can be kept alive, even if their progression through the training iterations is paused while the newly allocated workers catch up. This technical feature improves the reliability of computing devices.

In previous models, a single failure could disrupt or force the restart of an entire training job. A full set of workers may need to be newly allocated, and thus, the entire state must be copied from global storage and used to initialize each new worker. When checkpoint states are distributed and maintained locally in parallel, an entire agent, node, and/or pod can be rescued in the result of a failure by retrieving the checkpoint states from peers and either re-initializing or re-allocating the failed system components.

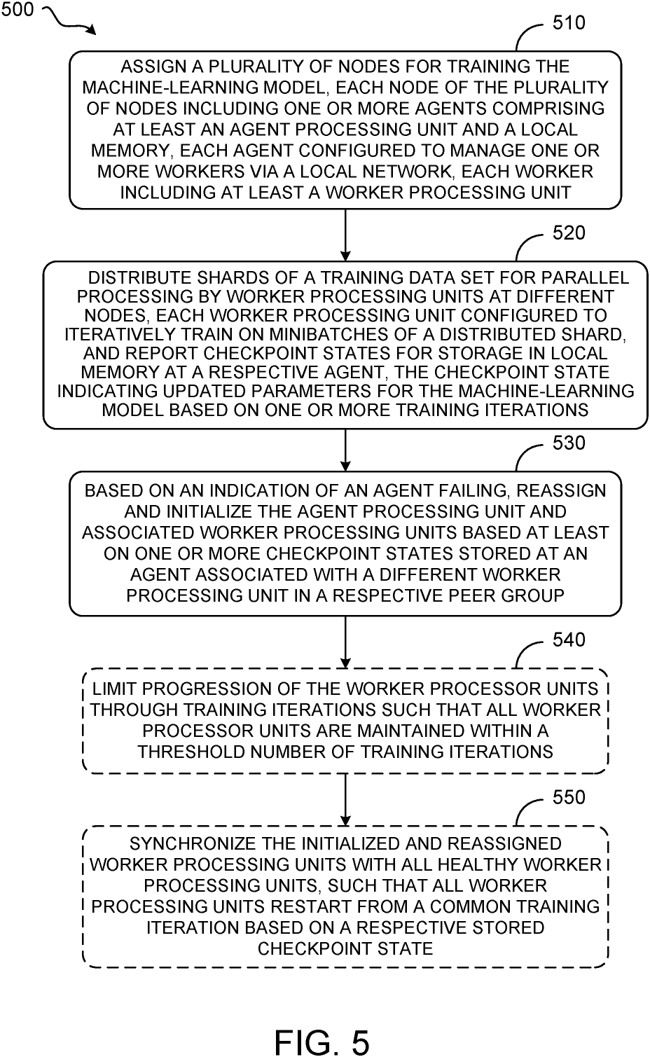

FIG. 5 is a flow chart for an example method 500 of training a machine-learning model. Method 500 may be executed by one or more computing systems, such as systems 300 and/or 400. More specifically, method 500 may be executed by a scheduler, such as schedulers 305 and/or 405, in communication with a plurality of nodes that can be configured to train a machine-learning model. The technical effect of implementing such a method is an improvement in the reliability of computing devices.

At 510, method 500 includes assigning a plurality of nodes for training the machine-learning model, each node of the plurality of nodes including one or more agents comprising at least an agent processing unit and a local memory, each agent configured to manage one or more workers via a local network, each worker including at least a worker processing unit. The number of assigned nodes may be based on available resources, such as processors, and further based on the size and complexity of the machine-learning model, training data set, etc. As described with regard to FIG. 4, each worker may further include worker memory, and local memory for each agent may include both volatile memory and non-volatile memory. A training process may be distributed to each agent.

At 520, method 500 includes distributing shards of a training data set for parallel processing by worker processing units at different nodes, each worker processing unit configured to iteratively train on minibatches of a distributed shard, and to report checkpoint states for storage in local memory at a respective agent, the checkpoint state indicating updated parameters for the machine-learning model based on one or more training iterations. Checkpoint states may thus be reported following each iteration or following a predetermined number of iterations. Minibatches may be stored in local memory for the agent and iteratively copied to worker memory. Checkpoint states may be copied from local memory at a first respective agent for storage at local memory associated with one or more additional agents of a peer group. In some examples, the one or more additional agents may be located on differing nodes from the first respective agent. A peer group, as used herein, may refer to agent processor units that share checkpointing states and/or the worker processor units that provide the checkpointing states for storage at the agent processor units.

At 530, method 500 includes based on an indication of an agent failing, reassigning and initializing the agent and associated worker processing units based at least on one or more checkpoint states stored at an agent associated with a different worker processing unit in a respective peer group. All agents may be monitored for potential faults during and/or between training iterations. Failed agents may be detected at a node, within a pod, by the scheduler, and/or by processes running on the system. For example, an agent that reports a failed worker to the scheduler may cause the scheduler to initiate the restart process. If that agent fails to reply to the restart request within a threshold period of time the scheduler may indicate that the agent has failed. Agents that have numerous failed or stalled workers may self-report or indicate a susceptibility to failure. A most recent checkpoint state may be selected to initialize the reassigned agent and worker, though in some examples, the scheduler may indicate an older stored checkpoint state for initialization.

Agents that are reassigned may be reassigned to new or different nodes, and the reassigned agent may be provided on a different local network. Peer groups of agents may include two or more agents that may be contacted for exchanging stored checkpoint states. The agent that provides the stored checkpoint state may be selected based on which agent first responds to the request, available bandwidth, network proximity to the reassigned agent, etc.

In some examples, at 540, method 500 includes limiting progression of the worker processor units through training iterations such that all worker processor units are maintained within a threshold number of training iterations. As an example, each agent may be configured to store the threshold number of most recent checkpoint states for each associated worker processing unit. For example, each agent may be configured to store two, three, or more checkpoint states, with an oldest stored checkpoint state deleted when a new checkpoint state is recorded. This allows for some flexibility as compared to limiting progression to a next iteration until all worker processor units have completed a common iteration and copied their checkpoint state to their respective agent. Indeed, not all worker processor units will complete processing of each minibatch at the same time.

In some examples, at 550, method 500 includes synchronizing the initialized and reassigned worker processing units with all healthy worker processing units, such that all worker processing units restart from a common training iteration based on a respective stored checkpoint state (e.g., R:N, as described with regard to FIG. 4). As such, healthy worker processing units may be kept alive, though such workers may be paused or rolled back to the same checkpoint as the failed worker(s) if they have reached or passed the common training iteration. In some examples, synchronizing worker processing units may include limiting progression of all healthy worker processing units until the initialized and reassigned worker processing units have progressed to a common iteration based on a respective stored checkpoint state.

For all healthy worker processing units, even though they may revert a number of iterations to a previous checkpoint state, that checkpoint state is locally stored in the respective agent’s memory. As such, recovery for the healthy worker processing units merely includes copying the checkpoint state from the agent’s memory back to the worker’s memory. Only the replacement for the failed worker processing unit has to be initialized from a checkpoint state stored elsewhere.

In some examples, method 500 may include, based on an indication of a node failing, reassigning and initializing each agent and each associated worker processing unit of the node based at least on one or more checkpoint states stored at a different agent associated with a peer group for each worker processing unit of the failed node. In other words, as each worker processing unit may belong to a peer group that is distributed across nodes, agents, and even pods, rebuilding a failed node may necessitate retrieving checkpoint states stored at multiple agents across the system.

By implementing method 500, recovery from failures is made to be faster, and less work is lost or subject to being repeated. As checkpoints do not need to be recovered from global storage, less network bandwidth is used, both in checkpointing and in recovery. This saves power and other resources, creating a system that is both faster and more efficient.

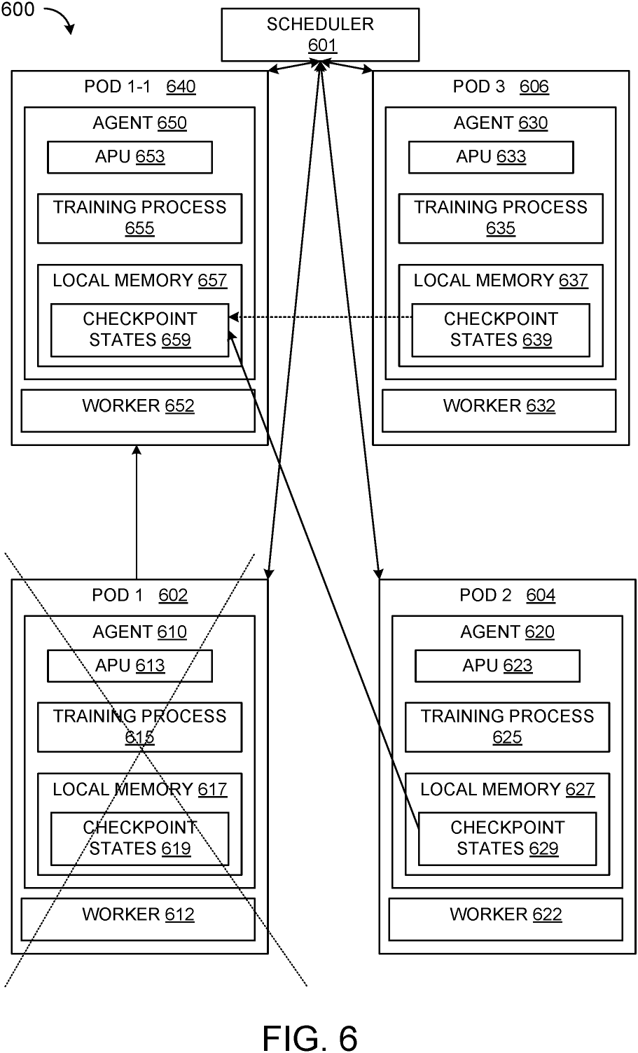

As an example, FIG. 6 schematically shows a system 600 for reassigning and initializing a failed node of a training system. System 600 includes scheduler 601, configured to communicate with pod 1 602, pod 2 604, and pod 3 606, among other pods. Pods are shown in simplified form, including one agent configured to manage one worker. The technical effect of implementing such a system is an improvement in the reliability of computing systems.

Pod 602 includes agent 610 and worker 612. Agent 610 includes at least agent processor unit (APU) 613, training process 615, and local memory 617, which may be configured to store checkpoint states 619. Pod 604 includes agent 620 and worker 622. Agent 620 includes at least APU 623, training process 625, and local memory 627, which may be configured to store checkpoint states 629. Pod 606 includes agent 630 and worker 632. Agent 620 includes at least APU 633, training process 635, and local memory 637, which may be configured to store checkpoint states 639. Workers 612, 622, and 632 may be included in a peer group such that agents 610, 620, and 630 exchange checkpoint states, and thus checkpoint states 619, 629, and 639 may include the same or similar state shares for equivalent training iterations.

Scheduler 601 may receive an indication of a failure to and/or within pod 1 602. Scheduler 601 then decides to terminate and reassign pod 1 602. Pod 640 is thus spawned. Pod 640 includes agent 650 and worker 652. Scheduler 601 may assign APU 653, provide training process 655, and assign local memory 657 to agent 650. Local memory 657 may be configured to store checkpoint states 659.

Checkpoint states 629, equivalent to checkpoint states 619, may be retrieved and copied to checkpoint states 659. Additionally or alternatively, checkpoint states 639 may be retrieved and copied to checkpoint states 659. Workers 622 and 632 may then be maintained at, or rolled back to, a determined common checkpoint state until worker 652 has been initialized and caught up and is ready to advance past the common checkpoint state.

The systems described with regard to FIGS. 3, 4, and 6, and the method described with regard to FIG. 5 allow for the performance of very fast checkpointing and very fast recovery. As described, this allows for an increase in the reliability of recovery from failures. However, they also allow for proactively making training operations more efficient by encouraging resource sharing. Jobs can be shrunk or grown depending on the availability of resources.

In scenarios where there are idle nodes, bandwidth usage can be shifted from node to node within the cluster to use for other training tasks. This allows for the leveraging of free or available resources. Nodes can also be programmed to be benevolent and shrink the footprint of a task to provide additional resources. For example, if a node runs quickly through a mini-batch, and cannot advance because it is iteration-capped, that node can lend processing power to slower or more challenging tasks, or aid nodes that had to restart and fell behind. State shards are saved, so those tasks can be recovered or re-deployed when bandwidth becomes more readily available.

As used herein, elasticity refers to the footprint for a task within the cluster and how it can be expanded or contracted based on resource needs of cluster co-tenants. The cluster can also proactively perform migration of nodes or tasks. Any task can be aborted and picked up somewhere else at the most recent checkpoint.

Within a large cluster, there will be local network traffic between some workers, while others are physically distant. Elasticity may be used to perform optimum distribution if and when local bandwidth opens up, or to push redundant tasks to distantly located workers to stave off common failures. For example, a replacement for a failed node may be assigned to a sub-optimal location based on bandwidth availability at the time of failure. As bandwidth changes across the system over time, the replacement node can be opportunistically migrated to a more optimal location.

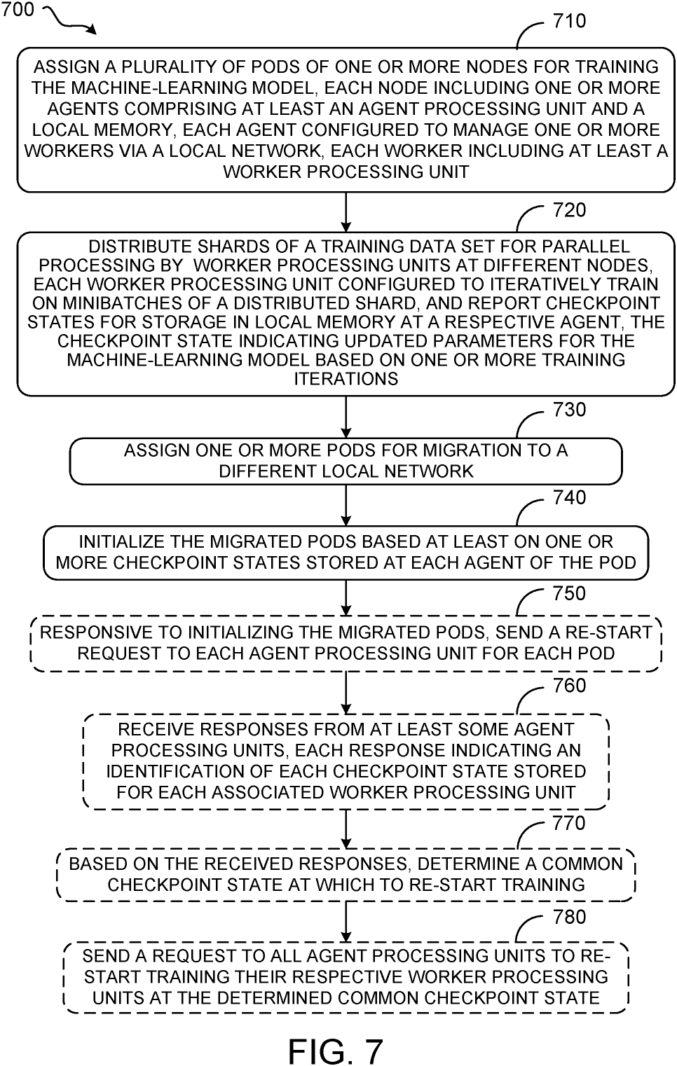

FIG. 7 is a flow chart for an example method 700 of managing training of a machine-learning model. Method 700 may be executed by one or more computing systems, such as systems 300 and/or 400. More specifically, method 700 may be executed by a scheduler, such as schedulers 305 and/or 405, in communication with a plurality of nodes that can be configured to train a machine-learning model. The technical effect of implementing such a system is an optimization of consumption of computing resources.

At 710, method 700 includes assigning a plurality of pods of one or more nodes for training the machine-learning model, each node including one or more agents comprising at least an agent processing unit and a local memory, each agent configured to manage one or more workers via a local network each worker including at least a worker processing unit. This assignment may be performed in a similar fashion as is described at 510 of method 500. Each pod may include one or more nodes, and peer groups of workers may preferentially be assigned to different pods to reduce the risk of common failure. Nodes commonly assigned to a pod may share common local resources.

At 720, method 700 includes distributing shards of a training data set for parallel processing by worker processing units at different nodes, each worker processing unit configured to iteratively train on minibatches of a distributed shard, and to report checkpoint states for storage in local memory at a respective agent, the checkpoint state indicating updated parameters for the machine-learning model based on one or more training iterations. This distribution may be performed in a similar fashion as is described at 520 of method 500.

At 730, method 700 includes assigning one or more pods for migration to a different local network. In some examples, pods are assigned for migration based on available bandwidth on local networks. Pods may be assigned for migration based on optimizing the location of pods relative to each other, for consolidating jobs, or any other suitable reason. In some examples, pods or nodes may simply be deleted, and/or some nodes within a pod may not be co-migrated.

At 740, method 700 includes initializing the migrated pods based at least on one or more checkpoint states stored at each agent of the pod. The original pod may then be reassigned as desired. In some examples, the checkpoint states may be retrieved from the respective agents of peer worker groups.

In some examples, at 750 method 700 includes, responsive to initializing the migrated pods, sending a re-start request to each agent processing unit for each pod. The re-start request may include initialization information regarding the migrated pod, as well as a request to provide status information for each pod worker, including which checkpoint states are currently being stored in local memory.

In examples wherein re-start requests are sent, method 700 may include, at 760, receiving responses from at least some agent processing units, each response indicating an identification of each checkpoint state stored for each associated worker processing unit. In examples where responses are received, method 700 may include, at 770, based on the received responses, determining a common checkpoint state at which to re-start training. In some examples, the common checkpoint state is determined in response to receiving a threshold number of responses from agent processing units. The scheduler may determine the N in checkpoint ids R:N to recover from, and then send a request to all agents to restart the workers from R:N.

In examples wherein a common checkpoint is determined, method 700 may include, at 780 sending a request to all agent processing units to re-start training their respective worker processing units at the determined common checkpoint state.

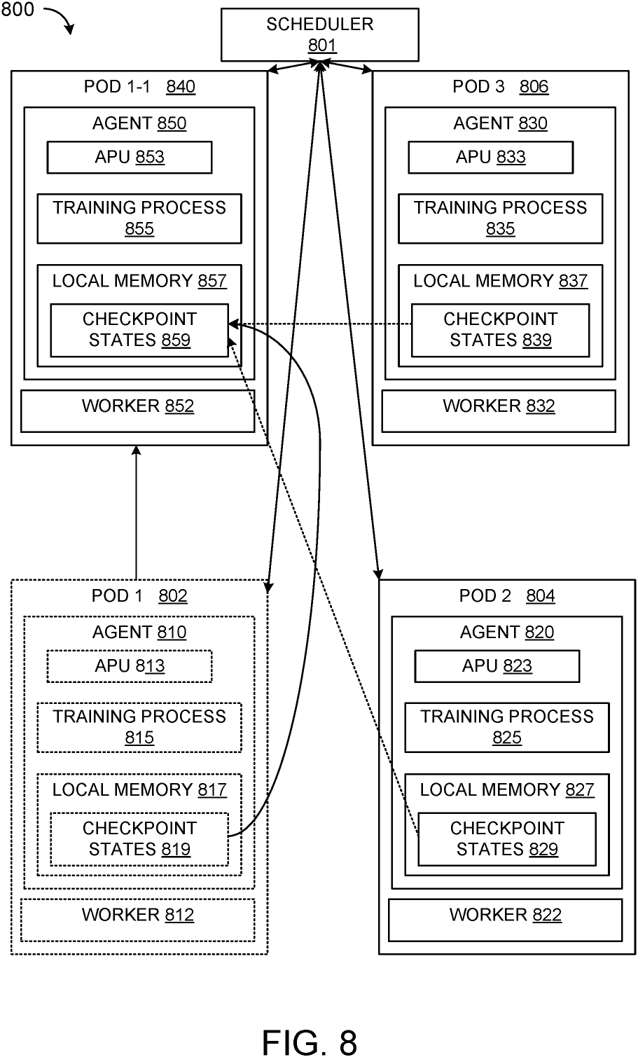

As an example, FIG. 8 schematically shows a system 800 for migrating a node of a training system. System 800 includes scheduler 801, configured to communicate with pod 1 802, pod 2 804, and pod 3 806, among other pods. Pods are shown in simplified form, including one agent configured to manage one worker.

Pod 802 includes agent 810 and worker 812. Agent 810 includes at least APU 813, training process 815, and local memory 817, which may be configured to store checkpoint states 819. Pod 804 includes agent 820 and worker 822. Agent 820 includes at least APU 823, training process 825, and local memory 827, which may be configured to store checkpoint states 829. Pod 806 includes agent 830 and worker 832. Agent 830 includes at least APU 833, training process 835, and local memory 837, which may be configured to store checkpoint states 839. Workers 812, 822, and 832 may be included in a peer group and be trained on the same shard of a data set, and thus checkpoint states 819, 829, and 839 may include the same or similar state shares for equivalent training iterations.

Scheduler 801 may make a determination to migrate pod 1 802 to a different local network. Scheduler 801 may then decide to terminate and reassign pod 1 802. Pod 840 is thus spawned. Pod 840 includes agent 850 and worker 852. Scheduler 801 may assign APU 853, provide training process 855, and assign local memory 857 to agent 850. Local memory 857 may be configured to store checkpoint states 859.

Prior to the termination of pod 1 802, checkpoint states 819, may be retrieved and copied to checkpoint states 859. Additionally or alternatively, checkpoint states 829 or 839 may be retrieved and copied to checkpoint states 859. Workers 822 and 832 may then be maintained at, or rolled back to, a determined common checkpoint state until worker 852 has caught up and is ready to advance past the common checkpoint state.

In some embodiments, the methods and processes described herein may be tied to a computing system of one or more computing devices. In particular, such methods and processes may be implemented as a computer-application program or service, an application-programming interface (API), a library, and/or other computer-program product.

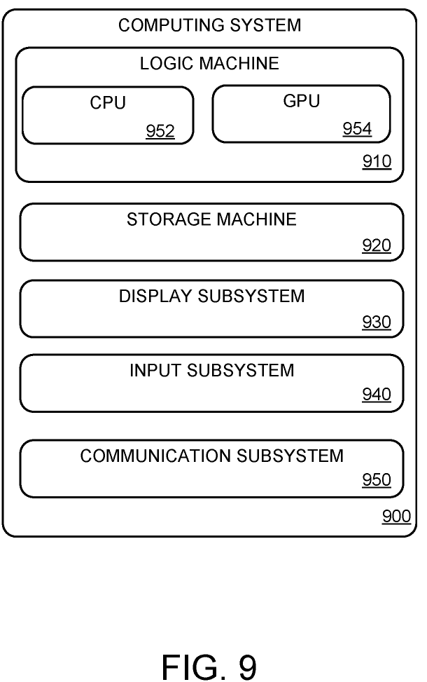

FIG. 9 schematically shows a non-limiting embodiment of a computing system 900 that can enact one or more of the methods and processes described above. Computing system 900 is shown in simplified form. Computing system 900 may take the form of one or more personal computers, server computers, tablet computers, home-entertainment computers, network computing devices, gaming devices, mobile computing devices, mobile communication devices (e.g., smart phone), and/or other computing devices. Systems 300, 400, 600, and 800 may be examples of computing system 900.

Computing system 900 includes a logic machine 910 and a storage machine 920. Computing system 900 may optionally include a display subsystem 930, input subsystem 940, communication subsystem 950, and/or other components not shown in FIG. 9.

Logic machine 910 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

The logic subsystem may include one or more CPUs 952 in addition to one or more GPUs 954, and the one or more CPUs 952 may be configured to send executable instructions and/or data to the one or more GPUs 954. Responsive to processing of the instructions and/or data by the one or more GPUs 954, the CPUs 952 may receive result data from the one or more GPUs 954. In this manner, the logic subsystem may execute a large number of computations in parallel via the GPUs. In particular, the logic subsystem may efficiently perform method 500 of FIG. 5 and method 700 of FIG. 7.

The present disclosure refers to a GPU as a computing device well-suited for distributed learning processes, because a GPU is configured to execute a very large number of multiple replicated instances of the same program (e.g., a GPU kernel) in parallel, where each instance of the program receives and works on different input data. However, it is to be understood that other aspects of a logic subsystem may be configured to provide the same or similar benefits. As such, it is to be understood that any discussion of GPUs also applies to other suitable computing components, and the present disclosure is in no way limited to performing method 500, 700, or any other aspect of training a machine-learning model on GPUs to the exclusion of other suitable computing devices.

Storage machine 920 includes one or more physical devices configured to hold instructions executable by the logic machine to implement the methods and processes described herein. When such methods and processes are implemented, the state of storage machine 920 may be transformed—e.g., to hold different data.

Storage machine 920 may include removable and/or built-in devices. Storage machine 920 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 920 may include volatile, nonvolatile, dynamic, static, read/write, read-only, random-access, sequential-access, location-addressable, file-addressable, and/or content-addressable devices.

It will be appreciated that storage machine 920 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 910 and storage machine 920 may be integrated together into one or more hardware-logic components. Such hardware-logic components may include field-programmable gate arrays (FPGAs), program- and application-specific integrated circuits (PASIC / ASICs), program- and application-specific standard products (PSSP / ASSPs), system-on-a-chip (SOC), and complex programmable logic devices (CPLDs), for example.

The terms “module,” “program,” and “engine” may be used to describe an aspect of computing system 900 implemented to perform a particular function. In some cases, a module, program, or engine may be instantiated via logic machine 910 executing instructions held by storage machine 920. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 930 may be used to present a visual representation of data held by storage machine 920. This visual representation may take the form of a graphical user interface (GUI). As the herein described methods and processes change the data held by the storage machine, and thus transform the state of the storage machine, the state of display subsystem 930 may likewise be transformed to visually represent changes in the underlying data. Display subsystem 930 may include one or more display devices utilizing virtually any type of technology. Such display devices may be combined with logic machine 910 and/or storage machine 920 in a shared enclosure, or such display devices may be peripheral display devices.

When included, input subsystem 940 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 950 may be configured to communicatively couple computing system 900 with one or more other computing devices. Communication subsystem 950 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

In one example, a method for training a machine-learning model comprises assigning a plurality of nodes for training the machine-learning model, each node of the plurality of nodes including one or more agents comprising at least an agent processing unit and a local memory, each agent configured to manage one or more workers via a local network, each worker including at least a worker processing unit; and distributing shards of a training data set for parallel processing by worker processing units at different nodes, each worker processing unit configured to: iteratively train on minibatches of a distributed shard, report checkpoint states for storage in local memory at a respective agent, the checkpoint state indicating updated parameters for the machine-learning model based on one or more training iterations, and based on recognizing a worker processing unit failing, initializing and restarting the failed worker processing unit based at least on a checkpoint state stored in local memory. The technical effect of implementing such a method is an improvement in the reliability of computing devices. In such an example, or any other example, the method additionally or alternatively comprises limiting progression of the worker processor units through training iterations such that all worker processor units are maintained within a threshold number of training iterations. The technical effect of implementing such a method is an improvement in the reliability of computing devices. In any of the preceding examples, or any other example, each agent is additionally or alternatively configured to store the threshold number of most recent checkpoint states for each associated worker processing unit. In any of the preceding examples, or any other example, the method additionally or alternatively comprises synchronizing the initialized and reassigned worker processing units with all healthy worker processing units, such that all worker processing units restart from a common training iteration based at least on a respective stored checkpoint state. The technical effect of implementing such a method is an improvement in the reliability of computing devices. In any of the preceding examples, or any other example, the method additionally or alternatively comprises limiting progression of all healthy worker processing units until the initialized and reassigned worker processing units have progressed to a common iteration based at least on a respective stored checkpoint state. The technical effect of implementing such a method is an improvement in the reliability of computing devices. In any of the preceding examples, or any other example, the method additionally or alternatively comprises based at least on an indication of an agent failing, reassigning and initializing the agent and associated worker processing units based at least on one or more checkpoint states stored at an agent associated with a different worker processing unit in a respective peer group. The technical effect of implementing such a method is an improvement in the reliability of computing devices. In any of the preceding examples, or any other example, the method additionally or alternatively comprises, based at least on an indication of a node failing, reassigning and initializing each agent and each associated worker processing unit of the node based at least on one or more checkpoint states stored at a different agent associated with a worker processing unit in a peer group for each worker processing unit of the failed node. The technical effect of implementing such a method is an improvement in the reliability of computing devices. In any of the preceding examples, or any other example, each agent is additionally or alternatively configured to upload checkpoint states from local memory to a global backup at a lower frequency than the checkpoint states are recorded at the respective agent. The technical effect of implementing such a method is a recued consumption of computing resources. In any of the preceding examples, or any other example, each worker is additionally or alternatively configured to report checkpoint states based at least on a most recent training iteration to a respective agent following progression of the worker to a subsequent training iteration. The technical effect of implementing such a method is an improvement in the reliability of computing devices.

In another example, a method for managing training of a machine-learning model comprises assigning a plurality of nodes of one or more pods for training the machine-learning model, each pod including one or more agents comprising at least an agent processing unit and a local memory, each agent configured to manage one or more workers via a local network, each worker including at least a worker processing unit; distributing shards of a training data set for processing by worker processing units at different nodes, each worker processing unit configured to: iteratively train on minibatches of a distributed shard, and report checkpoint states for storage in local memory at a respective agent, the checkpoint state indicating updated parameters for the machine-learning model based on one or more training iterations; assigning one or more pods for migration to a different local network; and initializing the migrated pods based at least on one or more checkpoint states stored at each agent of the pod. The technical effect of implementing such a method enables the optimized consumption of computing resources. In such an example, or any other example, the method additionally or alternatively comprises, responsive to initializing the migrated pods, sending a re-start request to each agent processing unit for each pod; receiving responses from at least some agent processing units, each response indicating an identification of each checkpoint state stored for each associated worker processing unit; based on the received responses, determining a common checkpoint state at which to re-start training; and sending a request to all agent processing units to re-start training their respective worker processing units at the determined common checkpoint state. The technical effect of implementing such a method is an optimized consumption of computing resources. In any of the preceding examples, or any other example, the common checkpoint state is additionally or alternatively determined in response to receiving a threshold number of responses from agent processing units. In any of the preceding examples, or any other example, pods are additionally or alternatively assigned for migration based on available bandwidth on local networks. The technical effect of implementing such a method is a reduction in the consumption of computing resources.

In yet another example, a computing system for training a machine-learning model comprises a plurality of agents comprising at least an agent processing unit and a local memory, each agent configured to manage one or more workers via a local network, each worker including at least one worker processing unit; a plurality of worker processing units configured to: iteratively train on minibatches of a distributed shard, and report checkpoint states for storage in local memory at a respective agent, the checkpoint state indicating updated parameters for the machine-learning model based on one or more training iterations; a scheduler configured to: assign a plurality of nodes of one or more pods for training the machine-learning model, each pod including one or more agents; each agent distributing shards of a training data set for processing by a worker processing unit; based at least on an indication of an agent failing, reassign and initialize the agent and associated worker processing units based at least on one or more checkpoint states stored at an agent associated with a different worker processing unit in a respective peer group. This technical feature provides improved reliability of computing devices. In such an example, or any other example, the scheduler is additionally or alternatively configured to limit progression of the worker processor units through training iterations such that all worker processor units are maintained within a threshold number of training iterations. This technical feature provides improved reliability of computing devices. In any of the preceding examples, or any other example, each agent is additionally or alternatively configured to store the threshold number of most recent checkpoint states for each associated worker processing unit. In any of the preceding examples, or any other example, the scheduler is additionally or alternatively configured to synchronize the initialized and reassigned worker processing units with all healthy worker processing units, such that all worker processing units restart from a common training iteration based at least on a respective stored checkpoint state. This technical feature provides improved reliability of computing devices. In any of the preceding examples, or any other example, the scheduler is additionally or alternatively configured to limit progression of all healthy worker processing units until the initialized and reassigned worker processing units have progressed to a common iteration based at least on a respective stored checkpoint state. This technical feature provides improved reliability of computing devices. In any of the preceding examples, or any other example, the scheduler is additionally or alternatively configured to: assign one or more nodes for migration to a different local network, each node including one or more pods; and initialize the migrated nodes based at least on one or more checkpoint states stored at each agent of the node. This technical feature provides optimized consumption of computing resources. In any of the preceding examples, or any other example, the scheduler is additionally or alternatively configured to: responsive to initializing the migrated nodes, send a re-start request to each agent processing unit for each node of the plurality of nodes; receive responses from at least some agent processing units, each response indicating an identification of each checkpoint state stored for each associated worker processing unit; based on the received responses, determine a common checkpoint state at which to re-start training; and send a request to all agent processing units to re-start training their respective worker processing units at the determined common checkpoint states. This technical feature provides optimized consumption of computing resources.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for training a machine-learning model, comprising:
assigning a plurality of nodes for training the machine-learning model, each node of the plurality of nodes including one or more agents comprising at least an agent processing unit and a local memory, each agent configured to manage one or more workers via a local network, each worker including at least a worker processing unit; and
distributing shards of a training data set for parallel processing by worker processing units at different nodes, each worker processing unit configured to:
iteratively train on minibatches of a distributed shard,
report checkpoint states for storage in local memory at a respective agent, the checkpoint state indicating updated parameters for the machine-learning model based on one or more training iterations, and
based on recognizing a worker processing unit failing, initializing and restarting the failed worker processing unit based at least on a checkpoint state stored in local memory.

2. The method of claim 1, further comprising:
limiting progression of the worker processor units through training iterations such that all worker processor units are maintained within a threshold number of training iterations.

3. The method of claim 2, wherein each agent is configured to store the threshold number of most recent checkpoint states for each associated worker processing unit.

4. The method of claim 3, further comprising:
synchronizing the initialized and reassigned worker processing units with all healthy worker processing units, such that all worker processing units restart from a common training iteration based at least on a respective stored checkpoint state.

5. The method of claim 3, further comprising:
limiting progression of all healthy worker processing units until the initialized and reassigned worker processing units have progressed to a common iteration based at least on a respective stored checkpoint state.

6. The method of claim 1, further comprising:
based at least on an indication of an agent failing, reassigning and initializing the agent and associated worker processing units based at least on one or more checkpoint states stored at an agent associated with a different worker processing unit in a respective peer group.

7. The method of claim 6, further comprising:
based at least on an indication of a node failing, reassigning and initializing each agent and each associated worker processing unit of the node based at least on one or more checkpoint states stored at a different agent associated with a worker processing unit in a peer group for each worker processing unit of the failed node.

8. The method of claim 1, wherein each agent is further configured to upload checkpoint states from local memory to a global backup at a lower frequency than the checkpoint states are recorded at the respective agent.

9. The method of claim 1, wherein each worker is configured to report checkpoint states based at least on a most recent training iteration to a respective agent following progression of the worker to a subsequent training iteration.

10. A method for managing training of a machine-learning model, comprising:
assigning a plurality of nodes of one or more pods for training the machine-learning model, each pod including one or more agents comprising at least an agent processing unit and a local memory, each agent configured to manage one or more workers via a local network, each worker including at least a worker processing unit;
distributing shards of a training data set for processing by worker processing units at different nodes, each worker processing unit configured to:
iteratively train on minibatches of a distributed shard, and
report checkpoint states for storage in local memory at a respective agent, the checkpoint state indicating updated parameters for the machine-learning model based on one or more training iterations;
assigning one or more pods for migration to a different local network; and
initializing the migrated pods based at least on one or more checkpoint states stored at each agent of the pod.

11. The method of claim 10, further comprising:
responsive to initializing the migrated pods, sending a re-start request to each agent processing unit for each pod;
receiving responses from at least some agent processing units, each response indicating an identification of each checkpoint state stored for each associated worker processing unit;
based on the received responses, determining a common checkpoint state at which to re-start training; and
sending a request to all agent processing units to re-start training their respective worker processing units at the determined common checkpoint state.

12. The method of claim 11, wherein the common checkpoint state is determined in response to receiving a threshold number of responses from agent processing units.

13. The method of claim 10, wherein pods are assigned for migration based on available bandwidth on local networks.

14. A computing system for training a machine-learning model, comprising:
a plurality of agents comprising at least an agent processing unit and a local memory, each agent configured to manage one or more workers via a local network, each worker including at least one worker processing unit;
a plurality of worker processing units configured to:
iteratively train on minibatches of a distributed shard, and
report checkpoint states for storage in local memory at a respective agent, the checkpoint state indicating updated parameters for the machine-learning model based on one or more training iterations;
a scheduler configured to:
assign a plurality of nodes of one or more pods for training the machine-learning model, each pod including one or more agents; each agent distributing shards of a training data set for processing by a worker processing unit;
based at least on an indication of an agent failing, reassign and initialize the agent and associated worker processing units based at least on one or more checkpoint states stored at an agent associated with a different worker processing unit in a respective peer group.

15. The computing system of claim 14, wherein the scheduler is further configured to:
limit progression of the worker processor units through training iterations such that all worker processor units are maintained within a threshold number of training iterations.

16. The computing system of claim 15, wherein each agent is configured to store the threshold number of most recent checkpoint states for each associated worker processing unit.

17. The computing system of claim 15, wherein the scheduler is further configured to:
synchronize the initialized and reassigned worker processing units with all healthy worker processing units, such that all worker processing units restart from a common training iteration based at least on a respective stored checkpoint state.

18. The computing system of claim 15, wherein the scheduler is further configured to:
limit progression of all healthy worker processing units until the initialized and reassigned worker processing units have progressed to a common iteration based at least on a respective stored checkpoint state.

19. The computing system of claim 14, wherein the scheduler is further configured to:
assign one or more nodes for migration to a different local network, each node including one or more pods; and
initialize the migrated nodes based at least on one or more checkpoint states stored at each agent of the node.

20. The computing system of claim 19, wherein the scheduler is further configured to:
responsive to initializing the migrated nodes, send a re-start request to each agent processing unit for each node of the plurality of nodes;
receive responses from at least some agent processing units, each response indicating an identification of each checkpoint state stored for each associated worker processing unit;
based on the received responses, determine a common checkpoint state at which to restart training; and
send a request to all agent processing units to re-start training their respective worker processing units at the determined common checkpoint states.
